(19) United States
(12) Patent Application Publication
(10) Pub. No.: US 2006/0164012 A1
(43) Pub. Date: Jul. 27, 2006

(54) Plasma display panel (PDP) and flat panel display including the PDP

(76) Inventors: Tae-Joung Kweon, Suwon-si (KR); Kyoung-Doo Kang, Suwon-si (KR)

Correspondence Address: Robert E. Bushnell;Suite 300, 1522 K Street, N.W., Washington, DC, 20005-1202, US

(21) Appl. No.: 11/336,903

(22) Filed: Jan. 23, 2006

(30) Foreign Application Priority Data
Jan. 26, 2005 (KR) 10-2005-0007213

(51) Int. Cl. H01J 17/49

(52) U.S. Cl. 313/582

(57) ABSTRACT

A Plasma Display Panel (PDP) with a great degree of freedom of design for an exhaust pipe and in which a low-voltage address discharge can occur, and an address voltage can be stably maintained, and a flat panel display including the PDP includes: a front substrate; a rear substrate arranged parallel to the front substrate; and a display area interposed between the front substrate and the rear substrate, wherein the widths of regions between at least two opposite edges of the display area and boundary lines of a region where the front substrate and the rear substrate overlap are asymmetric with respect to a center of the display area. Accordingly, an exhaust pipe can be freely arranged, a low-voltage address discharge is possible, and maintenance of an address voltage is improved.

### CLAIM OF PRIORITY

This application makes reference to, incorporates the same herein, and claims all benefits accruing under 35 U.S.C. § 119 from an application for PLASMA DISPLAY PANEL AND FLAT DISPLAY DEVICE COMPRISING THE SAME earlier filed in the Korean Intellectual Property Office on 26 Jan. 2005 and there duly assigned Serial No. 10-2005-0007213.

### BACKGROUND OF THE INVENTION

1. Field of the Invention

The present invention relates to a Plasma Display Panel (PDP) and a flat panel display including the PDP, and more particularly, to a PDP in which interference between an exhaust pipe and a display area can be prevented, and a flat panel display including the PDP.

2. Description of the Related Art

Flat panel displays, including PDPs, have a large screen size and good characteristics, such as high resolution, thinness and lightness, and large viewing angle. In addition, a method of manufacturing such a display is simpler than methods of manufacturing other flat panel displays, and it is easy to increase its size. Therefore, the plasma display is expected to be the next generation large flat panel display.

A PDP is formed by joining a front substrate and a rear substrate opposite to each other and displays an image as a result of a discharge induced between the two substrates. Furthermore, the PDP includes an exhaust pipe for discharging impurities or gases generated during the joining of the front and rear substrate and manufacturing processes. The exhaust pipe is formed on either the front substrate or the rear substrate.

In a PDP, a display area is located substantially at the center of a boundary region in which the front substrate and the rear substrate overlap. Accordingly, the exhaust pipe interferes with the display area unless a sufficiently large dummy area is provided outside the display area.

To solve the above problem, the size of the substrate must be increased.

PDPs are classified into Direct Current (DC) PDPs, Alternating Current (AC) PDPs, and hybrid PDPs according to an applied discharge voltage, and are classified into opposite discharge PDPs and surface discharge PDPs according to a discharge structure.

In the DC PDP, all electrodes are exposed to a discharge space and charges directly move between corresponding electrodes. In the AC PDP, at least one electrode is covered by a dielectric layer, and a discharge occurs due to an electric field of wall charges, instead of the charges directly moving between corresponding electrodes.

Since the electrodes in the DC PDP are seriously damaged because charges directly move between the corresponding electrodes, the AC PDP has been widely used in recent years.

In the AC PDP, address electrodes, X electrodes, and Y electrodes are arranged to surround discharge spaces defined by a front substrate, a rear substrate and barrier ribs. Regarding discharge, an address discharge first occurs between the address electrode and the X electrode or the Y electrode, and subsequently, a sustain discharge occurs between the X electrode and the Y electrode.

However, in the AC PDP, the discharge path between the address electrode and the X electrode or the Y electrode for an address discharge is long, so that an address discharge voltage increases, and it is difficult to maintain the address voltage.

### SUMMARY OF THE INVENTION

The present invention provides a Plasma Display Panel (PDP) with a great degree of freedom of design for an exhaust pipe, and a flat panel display including the PDP.

The present invention also provides a PDP in which a low-voltage address discharge can occur, and an address voltage can be stably maintained, and a flat panel display including the PDP.

According to one aspect of the present invention, a PDP is provided including: a front substrate; a rear substrate arranged parallel to the front substrate; and a display area interposed between the front substrate and the rear substrate; the widths of regions between at least two opposite edges of the display area and boundary lines of a region where the front substrate and the rear substrate overlap are asymmetric with respect to a center of the display area.

The front substrate preferably includes an exhaust pipe adapted to exhaust air from a space between the front substrate and the rear substrate.

The exhaust pipe is preferably arranged between the edges of the display area and the boundary lines of the region where the front substrate and the rear substrate overlap.

Upon the boundary lines of the region where the front substrate and the rear substrate overlapping as a rectangle, the widths of regions between two parallel long-side boundary lines of the rectangle and two edges of the display area are respectively a first width and a second width, and the widths of regions between two parallel short-side boundary lines of the rectangle and two edges of the display area are respectively a third width and a fourth width, the first width is preferably larger than the second width, and the third width is preferably larger than the fourth width.

The front substrate preferably includes an exhaust pipe adapted to exhaust air from a space between the front substrate and the rear substrate, and the exhaust pipe is preferably arranged in at least one of the regions with the first and third widths.

The rear substrate preferably includes a metallic material.

The display area preferably includes: a plurality of barrier ribs interposed between the front substrate and the rear substrate to define discharge cells together with the front substrate and the rear substrate; a plurality of electrodes arranged to surround each of the discharge cells; and a plurality of fluorescent layers arranged in each of the discharge cells.

The plurality of electrodes are preferably buried in the barrier ribs and include a plurality of discharge electrodes arranged in pairs. The plurality of electrodes preferably include a plurality of address electrodes buried in the rear substrate. The plurality of electrodes preferably include a plurality of address electrodes buried in the barrier ribs.

At least surfaces of the barrier ribs are preferably covered with a protective film.

The fluorescent layer is preferably arranged on a surface of the front substrate facing the rear substrate.

According to another aspect of the present invention, a flat display including the above-described PDP is provided.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a front view of a Plasma Display Panel (PDP) according to an embodiment of the present invention;

FIG. 2 is a sectional view of a PDP according to an embodiment of the present invention;

FIG. 3 is a perspective view of the electrode structure of the PDP of FIG. 2;

FIG. 4 is a sectional view of a PDP according to another embodiment of the present invention to which the structure of FIG. 1 is applied;

FIG. 5 is a perspective view of the electrode structure of the PDP of FIG. 4;

FIG. 6 is a sectional view of a PDP according to another embodiment of the present invention to which the structure of FIG. 1 is applied;

FIG. 7 is a perspective view of the electrode structure of the PDP of FIG. 6;

FIGS. 8 and 9 are sectional views of modifications of the PDP of FIG. 6;

FIG. 10 is a sectional view of a PDP according to a another embodiment of the present invention to which the structure of FIG. 1 is applied;

FIG. 11 is a sectional view of a modification of the PDP of FIG. 10;

FIG. 12 is a sectional view of an opposite discharge type PDP according to another embodiment of the present invention to which the structure of FIG. 1 is applied;

FIG. 13 is a perspective view of the electrode structure of the PDP of FIG. 12; and

FIG. 14 is a sectional view of a PDP with a three-electrode surface discharge structure according to another embodiment of the present invention to which the structure of FIG. 1 is applied.

### DETAILED DESCRIPTION OF THE INVENTION

The present invention will now be described more fully with reference to the accompanying drawings, in which exemplary embodiments of the present invention are shown. The present invention can, however, be embodied in many different forms and should not be construed as being limited to the embodiments set forth herein. Rather, these embodiments are provided so that this disclosure will be thorough and complete, and will fully convey the concept of the present invention to those skilled in the art.

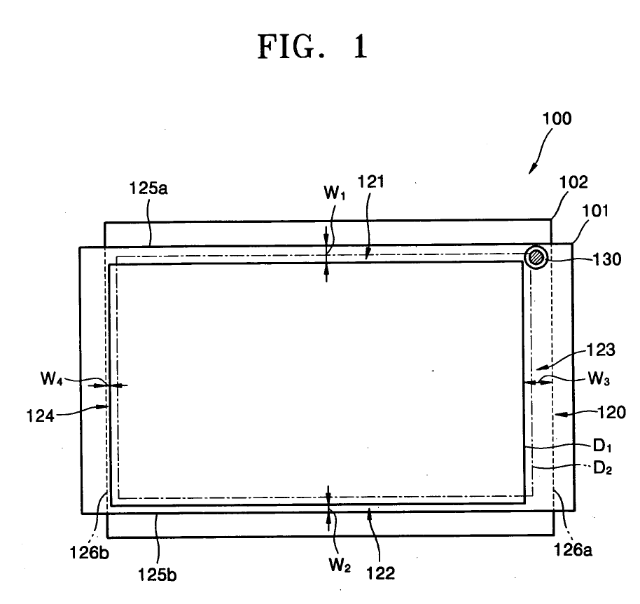

FIG. 1 is a front view of a PDP 100 according to an exemplary embodiment of the present invention.

The PDP 100 is formed by joining a front substrate 101 and a rear substrate 102 and displays an image on a front side of the front substrate 101.

A display area D1 is located between the front substrate 101 and the rear substrate 102. The display area D1 includes a plurality of discharge cells in which a discharge occurs, as described below, and a predetermined image is displayed on the display area D1 according to an external signal.

Referring to FIG. 1, the front substrate 101 and the rear substrate 102 have different sizes and are arranged crosswise, but the sizes and arrangement of the front and rear substrates 101 and 102 are not limited thereto. The front and rear substrates 101 and 102 can have the same size.

Regardless of the sizes of the front substrate 101 and the rear substrate 102, an overlapping region exists between the front substrate 101 and the rear substrate 102. In the present embodiment, the edges of the overlapping region between the front substrate 101 and the rear substrate 102 are referred to as boundary lines 120.

The display area D1 is in a region defined by the boundary lines 120. In the present invention, the widths between the edges of the display area D1 and the boundary lines 120 are unequal.

That is, referring to FIG. 1, in the PDP 100, the boundary lines 120 form a rectangle having a pair of first and second long-side boundary lines 125a and 125b parallel to each other and a pair of first and second short-side boundary lines 126a and 126b parallel to each other and perpendicular to the long-side boundary lines 125a and 125b.

The width of a region 121 between the first long-side boundary 125a and the display area D1 is referred to as a first width W₁, the width of a region 122 between the second long-side boundary 125b and the display area D1 is referred to as a second width W₂, the width of a region 123 between the first short-side boundary and the display area D1 is referred to as a third width W₃, and the width of a region 124 between the second short-side boundary and the display area D1 is referred to as a fourth width W₄. The first width W₁ and the third width W₃ are respectively larger than the second width W₂ and the fourth width W₄.

In other words, the display area D1 according to the present invention is arranged in a region between the boundary lines 120 to be shifted in a direction with respect to a display area D2.

When the display area D1 is formed in such a way, there is room in the regions 121 and 123 respectively having the first width W₁ and the third width W₃. Accordingly, when an exhaust pipe 130 is formed in the region 121 having the first width W₁ or the region 123 having the third width W₃ as shown in FIG. 1, the exhaust pipe 130 does not interfere with the display area D1 while the sizes of the front substrate 101 and the rear substrate 102 are maintained.

The above-described structure according to the present invention is advantageous especially when the exhaust pipe 130 is formed in the front substrate 101. When the exhaust pipe 130 is formed in the rear substrate 102, since an image is not displayed on the rear substrate 102, the problem of interference with the display area D1 is not important.

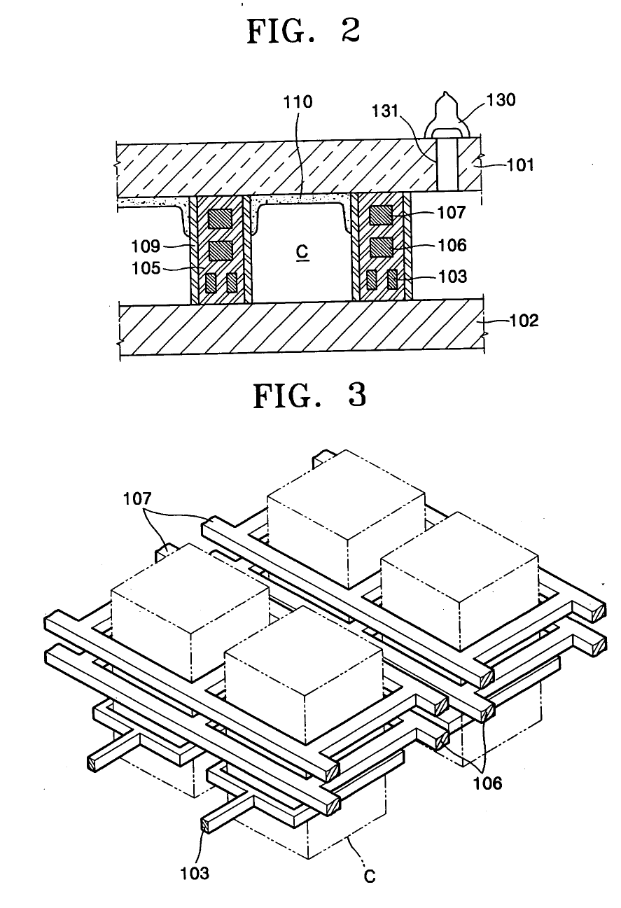

FIGS. 2 and 3 illustrate a PDP for which the above-described structure is suitable. In this PDP, since the rear substrate 102 is formed of metal, it can also act as a chassis base.

In particular, as described above, the front substrate 101 and the rear substrate 102 are arranged to face each other, and barrier ribs 105 that maintain a discharge distance and prevent electrical and optical cross-talk between pixels are formed between the front and rear substrates 101 and 102. Discharge cells C are partitioned by the front substrate 101, the rear substrate 102 and the barrier ribs 105. Each of discharge cell C is filled with a discharge gas, and edges of the front and rear substrates 101 and 102 are sealed by a sealing member (not shown) such as frit glass.

The front substrate 101 is formed of glass with a high transmittivity, and the rear substrate 102 is formed of metal. The rear substrate 102 has a predetermined rigidity to be used also as a chassis base.

The barrier ribs 105 are formed of a dielectric material on a rear surface of the front substrate 101. The cross-sections of the barrier ribs 105 can have a polygonal shape, for example, a triangular, rectangular, or pentagonal shape, a circular shape, an oval shape, etc. X-electrodes 107, Y-electrodes 106, and address electrodes 103 are embedded in the barrier ribs 105 so as to surround the discharge cells C, as shown in FIG. 3.

The address electrodes 103 extend in a direction to surround the discharge cells C, and the X electrodes 107 and the Y electrodes 103 extend in a direction perpendicular to the address electrodes 103 to surround the discharge cells C.

The X electrodes 107 and the Y electrodes 106 are arranged such that a discharge can occur between opposite surfaces of the X electrode 107 and the Y electrode 106 due to a difference between the voltages supplied to the X electrodes 107 and the Y electrodes 106. In the present embodiment, the X electrodes 107 and the Y electrodes 106 can be arranged in various patterns and positions as long as a surface discharge can occur in the side walls of the discharge cells C. The distance between the X electrodes 107 and the Y electrodes 106 is acceptable if a surface discharge can be initiated and diffused between the X electrodes 107 and the Y electrodes 106. However, the distance between the X and Y electrodes 107 and 106 should be as small as possible to enable low-voltage driving. A protective film 109 made of MgO, for example, can be formed on the surfaces of the barrier ribs 105 to protect the barrier ribs 105.

A fluorescent layer 110 which emits visible light rays when excited by ultraviolet rays generated by the discharge gas is formed in each of the discharge cells C. The fluorescent layer 110 can be formed in any region of the discharge cell C, but can be formed on the front substrate 101 in consideration of assembly processes, etc. To display a full-color image, the fluorescent layer 110 includes red, green, and blue phosphors, and one of the phosphors in three different colors is coated on each of the discharge cells C.

A discharge gas such as Ne, Xe, or a mixed gas composed of Ne and Xe fills each of the discharge cells C. In the present invention, since the discharge surface and the area of a discharge region increase, a larger amount of plasma is generated, enabling low-voltage driving. Therefore, according to the present invention, even when a high concentration of Xe gas is used as a discharge gas, low-voltage driving is possible, thereby markedly improving the luminous efficiency. Therefore, the problem that it is difficult to achieve low-voltage driving in a conventional PDP when a high concentration of Xe gas is used as a discharge gas can be solved.

The front substrate 101 does not include discharge electrodes formed of an Indium Tin Oxide (ITO) film, bus electrodes, and a dielectric layer covering the discharge electrode and bus electrodes, unlike a conventional PDP having discharge electrodes, bus electrodes, and a dielectric layer on its front substrate. Therefore, in the present invention, the aperture ratio of the front substrate 101 is markedly increased, and the transmission of visible rays is increased up to 90 percent, thereby enabling low-voltage driving and maximizing the luminous efficiency.

A penetrating hole 131 is formed outside the display area of the front substrate 101, and the exhaust pipe 130 for exhausting gas is externally attached to the front substrate 101.

In the PDP 100 according to the embodiment of the present invention, discharge occurs as follows.

When a predetermined address voltage is supplied between the address electrode 103 and the Y electrode 106 from an external power source, an address discharge occurs, and one of the discharge cells C is selected to emit light as a result of the address discharge, and wall charges are accumulated on the Y electrode 106 of the selected discharge cell C. Next, when a positive (+) voltage is supplied to the X electrode 107 and a voltage relatively lower than the positive (+) voltage is supplied to the Y electrode 106, the wall charges move due to the difference between the voltages supplied to the X and Y electrodes 107 and 106. The wall charges induce a discharge and produce a plasma while colliding with atoms of the discharge gas in the discharge cell C. Such a discharge is more likely to occur in a region where the X electrode 107 and the Y electrode 106 are close to each other and a relatively strong electric field has been formed. In the present embodiment, since the region where the X electrode 107 and the Y electrode 106 are close to each other is formed along the side walls of the discharge cell C, the probability of occurrence of a discharge is much higher than in a conventional PDP in which a region in which discharge electrodes are close to each other is formed only near an upper surface of the discharge space. When the voltage difference between the X and Y electrodes 107 and 106 is kept sufficiently large, the electric field formed between the opposite surfaces of the X and Y electrodes 107 and 106 gradually concentrates as time passes, and thus, the discharge spreads over the entire discharge cell C. In the present embodiment, since a discharge occurs in a ring pattern along four sides of the discharge cell C (when the barrier ribs 105 are arranged, for example, in a matrix pattern) and spreads from the four sides to the center of the discharge cell C, the spread area markedly increases. Furthermore, in the present embodiment, plasma produced by the discharge forms a ring pattern along the sides of the discharge cell C and spread toward the center of the discharge cell C, and thus, the volume of plasma steeply increases, the amount of visible rays markedly increases, and space charges can be utilized since the plasma is concentrated in the center of the discharge cell C, thereby enabling low-voltage driving and improving the luminous efficiency. Moreover, since the plasma is concentrated in the center of the discharge cell C and the electric fields due to the discharge electrodes 106 and 107 are formed at both sides of the plasma, the charges are concentrated in the center of the discharge cell C, thereby completely preventing ion sputtering against the fluorescent layer 110.

When the voltage difference between the X electrode 107 and the Y electrode 106 is smaller than a discharge voltage after the discharge occurs, a discharge no longer occurs and the space charges and wall charges are formed in the discharge cell C. When the polarities of the voltages supplied to the X electrode and the Y electrode are inverted, a discharge occurs again with the help of the wall charges. Thereafter, in a similar fashion as described above, the discharge spreads over the entire discharge cell C and then dissipates.

Then, when the polarities of the voltages supplied to the X and Y electrodes 107 and 106 are inverted again, initial discharge processes are repeated to induce a stable discharge.

However, the discharge processes are not limited to the above, and discharge can occur in various ways known to one skilled in the art.

In the embodiment according to the present invention described above, all the discharge electrodes 106 and 107 are formed in the barrier ribs 105, and thus, the aperture ratio increases. Moreover, the rear substrate 102 also acts as a chassis base, which simplifies the manufacturing processes and reduces the material cost and the unit manufacturing cost.

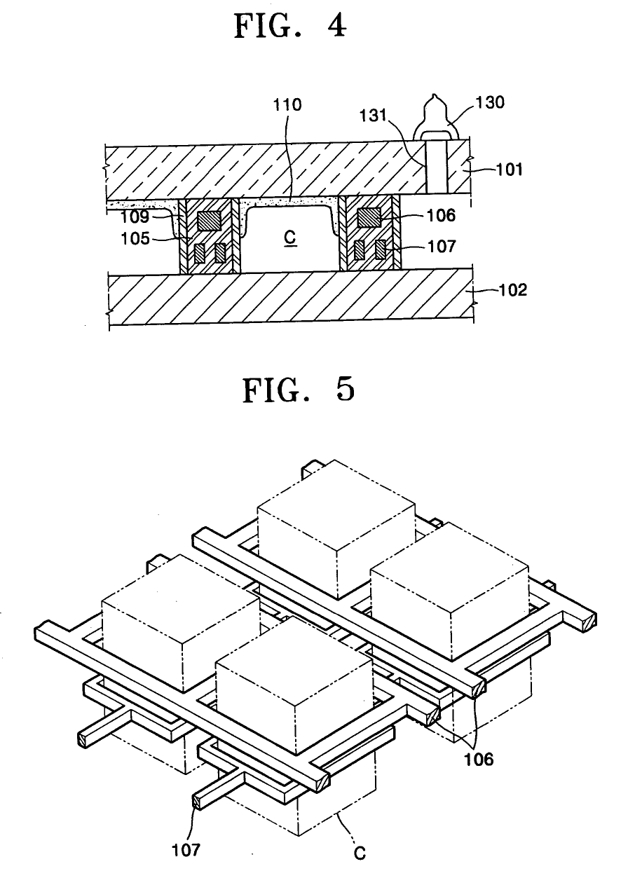

The featured structure according to the present invention of FIG. 1 can be applied not only to the structure of FIG. 2, but also to a structure of FIGS. 4 and 5 in which the X electrodes 107 and the Y electrodes 106 are formed perpendicular to each other, no separate address electrode is formed, and the X electrodes 107 or the Y electrodes act as address electrodes.

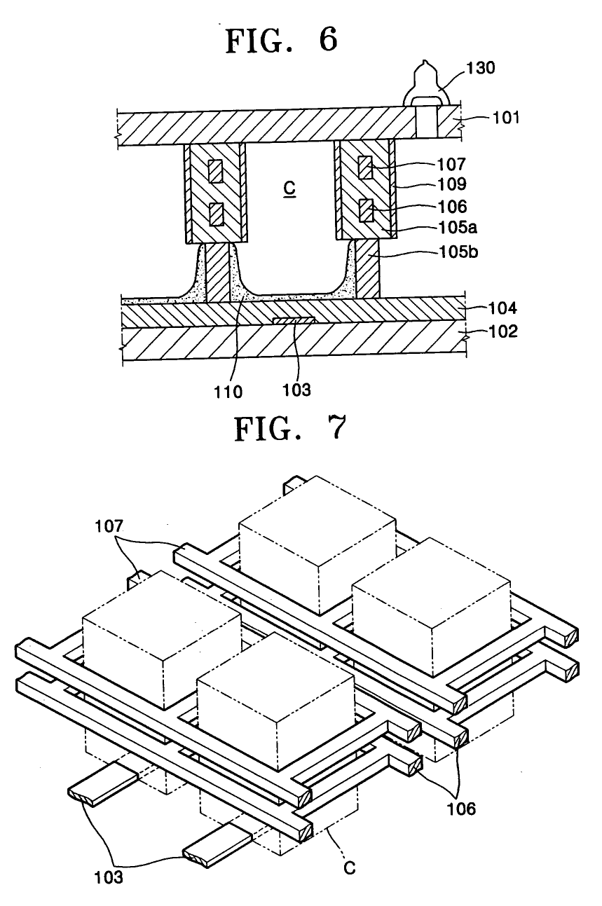

The structure of FIG. 1 can be applied to a structure according to another embodiment of the present invention shown in FIGS. 6 and 7. Referring to FIGS. 6 and 7, the address electrodes 103 are formed on the rear substrate 102, a dielectric layer 104 is formed to cover the address electrodes 103, and each of the barrier ribs includes a first barrier rib 105a extending from the front substrate 101 and a second barrier rib 105b extending from the rear substrate 102. The X electrode 107 and the Y electrode 106 are so arranged in the first barrier rib 105a as to enclose the discharge cell C, and the fluorescent layer 110 is formed on the side of the second barrier rib 105b and on the dielectric layer 104. A PDP with the above structure has an improved luminous efficiency because a dielectric substance or a fluorescent substance is not formed on the front substrate 101 through which light passes.

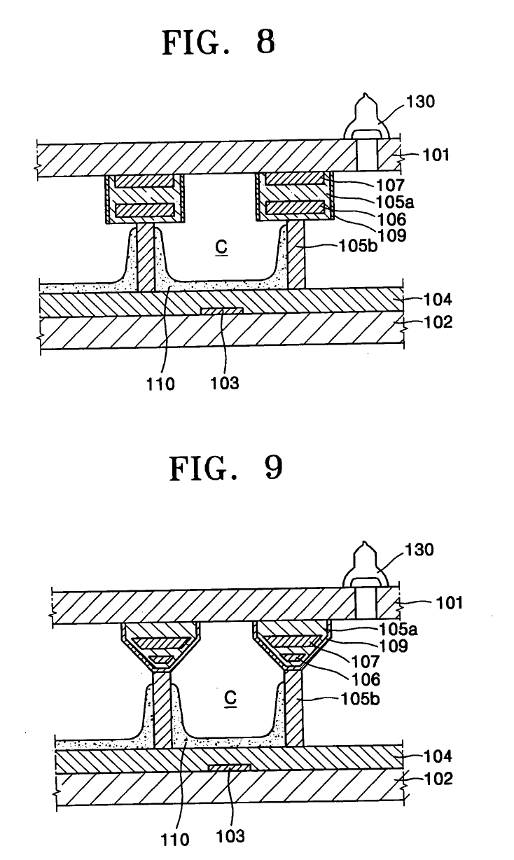

As an embodiment of the present invention, referring to FIG. 8, the first barrier rib 105a can be a circular cross-sectional shape, not a rectangular shape, and the X electrode 107 and the Y electrode 106 are horizontally arranged in the first barrier rib 105a to be parallel to the front substrate 101. In a PDP 200 with the present structure, a plasma can be easily concentrated. The structure of FIG. 1 can be applied to this present embodiment.

FIG. 9 is a sectional view of a PDP according to another embodiment of the present invention. Referring to FIG. 9, the structure of the PDP in the present embodiment is similar to the structure of FIG. 8, except that the discharge surface of the first barrier rib 105a is inclined, not perpendicular, with respect to the front substrate. In the PDP with this structure, a plasma can be more easily concentrated and spread toward the center of the discharge cell C. The structure of FIG. 1 can be applied to this present embodiment.

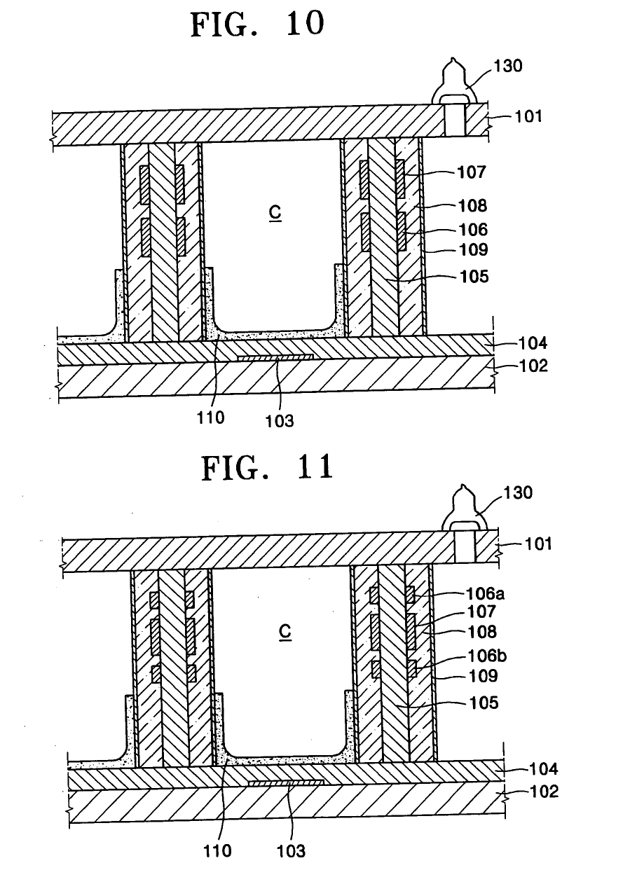

FIG. 10 is a sectional view of a PDP according to another embodiment of the present invention. Referring to FIG. 10, integrally formed barrier ribs 105 partition the discharge cells C, the X electrode 107 and the Y electrode 106 are formed on the sides of each of the barrier ribs 105, and a dielectric layer 108 is formed to cover the X and Y electrodes 107 and 106. The structure shown in FIG. 1 can be applied to this present embodiment.

FIG. 11 is a sectional view of a PDP according to another embodiment of the present invention. The PDP has the same barrier rib structure as the PDP of FIG. 10. Ring shaped Y electrodes 106a and 106b can be respectively disposed above and below or below and above a ring shaped X electrode. Such an arrangement of the X and Y electrodes 107, 106a and 106b allows a discharge surface to extend in the height direction of the discharge cell C. In this case, to lower the address voltage applied between the address electrode 103 and the Y electrode 106b, the Y electrode 106b can be arranged close to the address electrode 103, that is, close to the rear substrate 102. The structure of FIG. 1 can be applied to the present embodiment.

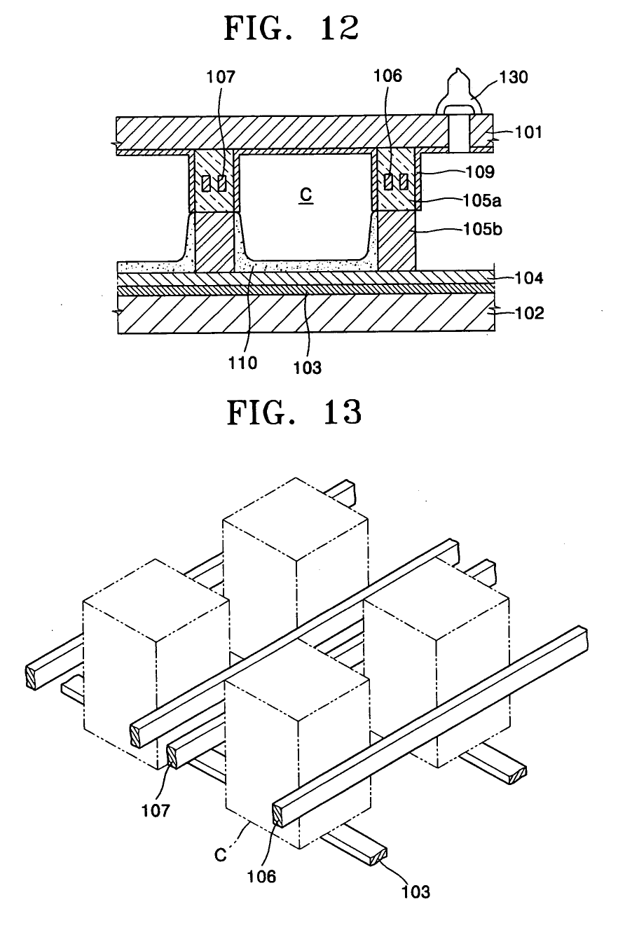

FIGS. 12 and 13 are respectively a sectional view and a perspective view of a PDP according to another embodiment of the present invention. Referring to FIGS. 12 and 13, each of the barrier ribs includes a first barrier rib 105a and a second barrier rib 105b as described above, and the X electrode 107 and the Y electrode 106 are arranged parallel to each other and spaced apart from each other in the first barrier rib 105a. Address electrodes 103 extend in a direction perpendicular to the X and Y electrodes 107 and 106 and are arranged on a front surface of the rear substrate 102. The address electrodes 103 extend to cross the discharge cells C and have stripe shapes. The address electrodes 103 are covered with a dielectric layer 104.

The structure of the PDP of FIGS. 12 and 13 is an example of an opposite discharge PDP, and the present invention can be applied to any opposite discharge PDP.

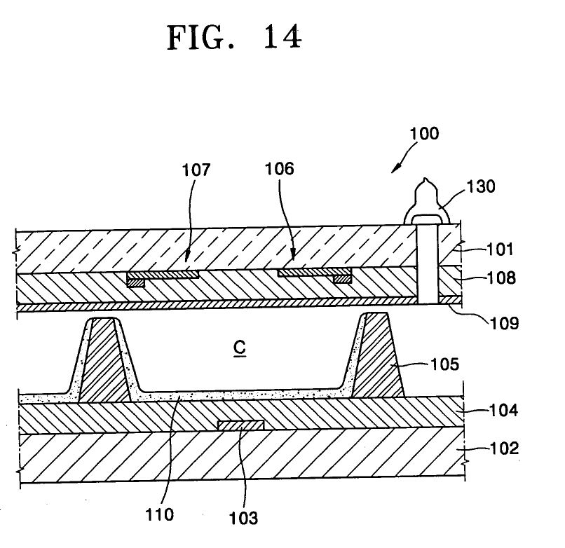

The present invention can be applied to a conventional three-electrode surface discharge PDP. In particular, referring to FIG. 14, an X electrode 107 and a Y electrode 106 are formed on a rear surface of a front substrate 101, a dielectric layer 108 is formed to cover the X and Y electrodes 107 and 106, and a protective film 109 is formed on the dielectric layer 108.

Furthermore, address electrodes 103 are formed on a rear substrate 102 in a stripe pattern, a dielectric layer 104 is sequentially formed to cover the address electrodes 103, and a barrier rib 105 is formed on dielectric layer 104 in a stripe pattern to extend in a direction parallel to the address electrodes 103, or in a matrix pattern. A fluorescent layer 110 is formed on the side of the barrier rib 105 and the top surface of the dielectric layer 104.

In the PDP according to the present embodiment, when a display area is designed as in FIG. 1, a degree of freedom in designing an exhaust pipe increases.

The PDP according to the embodiments described above, together with a driving circuit, can be included in a flat panel display device, such as a plasma display device, according to another embodiment of the present invention.

As described above, a PDP and a flat panel display device including the PDP according to the present invention have the following advantages:

First, a problem of interference between an exhaust pipe and a display area can be solved.

Second, since a rear substrate acts as a chassis base, the manufacturing processes are remarkably reduced and the cost can be reduced due to the reduction in materials.

Third, an electric field near an address electrode is strengthened, which allows an address voltage to be lowered.

Fourth, maintenance of address discharge voltage can be improved.

Fifth, the aperture ratio and transmission of visible light rays of a front substrate can be remarkably improved, and a surface on which a discharge occurs can be sharply enlarged. Furthermore, a discharge region can be expanded, and the volume and amount of plasma can be steeply increased. The plasma can be concentrated in the center of the discharge space. The luminous efficiency is improved, and even when a hyperbaric Xe gas is used as a discharge gas, the luminous efficiency can be improved. In addition, the discharge response speed is fast, low-voltage driving is possible, and permanent image retention can be completely prevented.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a front substrate;
a rear substrate arranged parallel to the front substrate; and
a display area interposed between the front substrate and the rear substrate;
wherein the widths of regions between at least two opposite edges of the display area and boundary lines of a region where the front substrate and the rear substrate overlap are asymmetric with respect to a center of the display area.

2. The PDP of claim 1, wherein the front substrate includes an exhaust pipe adapted to exhaust air from a space between the front substrate and the rear substrate.

3. The PDP of claim 2, wherein the exhaust pipe is arranged between the edges of the display area and the boundary lines of the region where the front substrate and the rear substrate overlap.

4. The PDP of claim 1, wherein, upon the boundary lines of the region where the front substrate and the rear substrate overlap as a rectangle, the widths of regions between two parallel long-side boundary lines of the rectangle and two edges of the display area are respectively a first width and a second width, and the widths of regions between two parallel short-side boundary lines of the rectangle and two edges of the display area are respectively a third width and a fourth width, the first width is larger than the second width, and the third width is larger than the fourth width.

5. The PDP of claim 4, wherein the front substrate includes an exhaust pipe adapted to exhaust air from a space between the front substrate and the rear substrate, and wherein the exhaust pipe is arranged in at least one of the regions with the first and third widths.

6. The PDP of claim 1, wherein the rear substrate comprises a metallic material.

7. The PDP of claim 1, wherein the display area comprises:
a plurality of barrier ribs interposed between the front substrate and the rear substrate to define discharge cells together with the front substrate and the rear substrate;
a plurality of electrodes arranged to surround each of the discharge cells; and
a plurality of fluorescent layers arranged in each of the discharge cells.

8. The PDP of claim 7, wherein the plurality of electrodes are buried in the barrier ribs and include a plurality of discharge electrodes arranged in pairs.

9. The PDP of claim 7, wherein the plurality of electrodes include a plurality of address electrodes buried in the rear substrate.

10. The PDP of claim 7, wherein the plurality of electrodes include a plurality of address electrodes buried in the barrier ribs.

11. The PDP of claim 7, wherein at least surfaces of the barrier ribs are covered with a protective film.

12. The PDP of claim 7, wherein the fluorescent layer is arranged on a surface of the front substrate facing the rear substrate.

13. A flat panel display, comprising:
a front substrate;
a rear substrate arranged parallel to the front substrate; and
a display area interposed between the front substrate and the rear substrate;
wherein the widths of regions between at least two opposite edges of the display area and boundary lines of a region where the front substrate and the rear substrate overlap are asymmetric with respect to a center of the display area.
